(19) United States
(12) Patent Application Publication
(10) Pub. No.: US 2026/0224341 A1
(43) Pub. Date: Aug. 6, 2026

(54) TOOTHBRUSH WITH TOOTHPASTE TABLET DISPENSER

(71) Applicant: Bryan Thrane, Temecula, CA (US)

(72) Inventor: Bryan Thrane, Temecula, CA (US)

(21) Appl. No.: 19/042,268

(22) Filed: Jan. 31, 2025

(51) Int. Cl. A61C 17/22; A46B 9/04; A46B 13/04

(52) U.S. Cl. CPC A61C 17/227; A46B 9/04; A46B 13/04

(57) ABSTRACT

A toothbrush includes a toothbrush top including a head with a plurality of toothbrush bristles. The toothbrush includes a handle coupled to the toothbrush top. The handle includes a chamber formed within an interior of the handle. The handle includes an opening positioned at a distal end of the handle and providing access to the cavity. The handle includes a cap removably coupled to the handle at the opening. The cap covers the opening. The handle includes a dispenser button coupled to the handle at a proximal end of the handle. The handle includes an ejection door coupled to the handle opposite the dispenser button. The toothbrush includes a toothpaste tablet cartridge storing a plurality of toothpaste tablets and configured to be inserted into the chamber. A topmost tablet of the plurality of toothpaste tablets is ejected from the ejection door when the dispenser button is actuated.

### FIELD

The present disclosure relates to dental devices and, more particularly, to toothbrushes.

### BACKGROUND

Traditional toothbrushes require the manual application of toothpaste from a tube or other container. This can be inconvenient and messy and can lead to excessive use of toothpaste.

As can be seen, there is a need for devices that address the above drawbacks.

### SUMMARY

In one aspect of the present disclosure, a toothbrush includes a toothbrush top including a head with a plurality of toothbrush bristles. The toothbrush also includes a handle coupled to the toothbrush top. The handle includes a chamber formed within an interior of the handle. The handle includes an opening positioned at a distal end of the handle and providing access to the cavity. The handle includes a cap removably coupled to the handle at the opening. The cap covers the opening. The handle includes a dispenser button coupled to the handle at a proximal end of the handle. The handle includes an ejection door coupled to the handle opposite the dispenser button. The toothbrush also includes a toothpaste tablet cartridge storing a plurality of toothpaste tablets and configured to be inserted into the chamber. A topmost tablet of the plurality of toothpaste tablets is ejected from the ejection door when the dispenser button is actuated.

In another aspect of the present disclosure, a toothbrush includes a toothbrush top including a head with a plurality of toothbrush bristles. The toothbrush also includes a handle coupled to the toothbrush top. The handle includes a chamber formed within an interior of the handle. The chamber is configured to receive a toothpaste tablet cartridge storing a plurality of toothpaste tablets. The handle also includes an opening positioned at a distal end of the handle and providing access to the cavity. The handle further includes a cap removably coupled to the handle at the opening. The cap covers the opening. The handle includes a dispenser button coupled to the handle at a proximal end of the handle. Further, the handle includes an ejection door coupled to the handle opposite the dispenser button. A topmost tablet of the plurality of toothpaste tablets is ejected from the ejection door when the dispenser button is actuated.

### BRIEF DESCRIPTION OF THE DRAWINGS

FIG. 1 is a perspective view of a toothbrush with an integrated toothpaste dispenser, according to aspects of the present disclosure;

FIG. 2 is a section view of the toothbrush taken along 2-2 in FIG. 1, according to aspects of the present disclosure; and

FIG. 3 is a section view of the toothbrush taken along 2-2 in FIG. 1 showing an operation of the dispenser, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, there is a need for a more efficient, user-friendly solution that allows for the convenient application of toothpaste while brushing. Broadly, an embodiment of the present disclosure provides a toothbrush with an integrated toothpaste tablet dispenser. The toothbrush includes a handle designed to house a cartridge containing toothpaste tablets. The handle is equipped with a spring-loaded mechanism and a button for the controlled dispensing of the tablets. This design ensures that users can easily access the toothpaste and apply it directly to the brush head without the need for separate toothpaste containers.

Accordingly, people can use the toothbrush with an integrated toothpaste tablet dispenser and save time and mess but not needing to carry toothpaste or separate tablets.

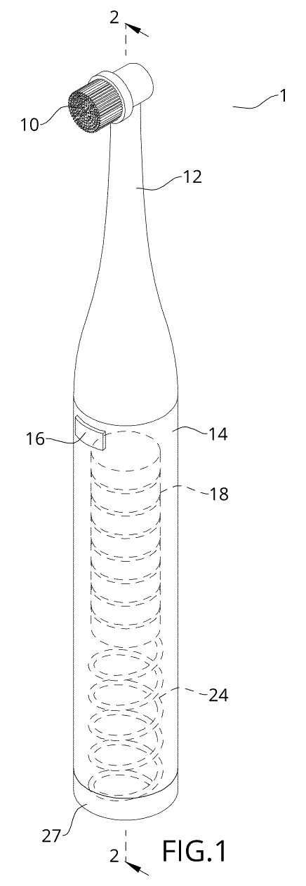

Referring now to FIG. 1-3, FIGS. 1-3 illustrate a toothbrush 1 that includes an integrated toothpaste dispenser, according to aspects of the present disclosure. While FIGS. 1-3 illustrate examples of components of toothbrush 1, additional components can be added and existing components can be removed and/or modified.

As illustrated in FIG. 1, the toothbrush 1 includes a top 12 and a handle 14. The top 12 and the handle 14 can be detachably coupled. The toothbrush handle 14 is ergonomically designed for comfortable grip and usage. The top 12 includes a head with bristles 10 for brushing a user’s teeth. In some embodiments, the toothbrush 1 can be a manually toothbrush in which the user provides the motion for brushing teeth. In some embodiments, the toothbrush 1 can be an electric toothbrush in which bristles are vibrated using an electric motor and/or actuator. In this embodiment, the toothbrush 1 can include necessary components of an electric toothbrush, e.g., power source, electric motor and/or actuator, drive system, activation switch, etc.

The handle 14 includes a cartridge chamber 11 formed within an interior of the handle 14. The cartridge chamber 11 can be accessed via an opening formed in a distal end of the handle 14, opposite the connection to the top 12. In some embodiments, the cartridge chamber 11 can be formed by having a cylindrical shape. The opening to the cartridge chamber 11 can be sealed with a cap 27. The cap 27 can include a biasing member, e.g., a spring, coupled to an interior surface of the cap 27. In some embodiments, the cap 27 can be a twist-off cap that includes threads that mate with threads formed on an interior surface of the cartridge chamber 11.

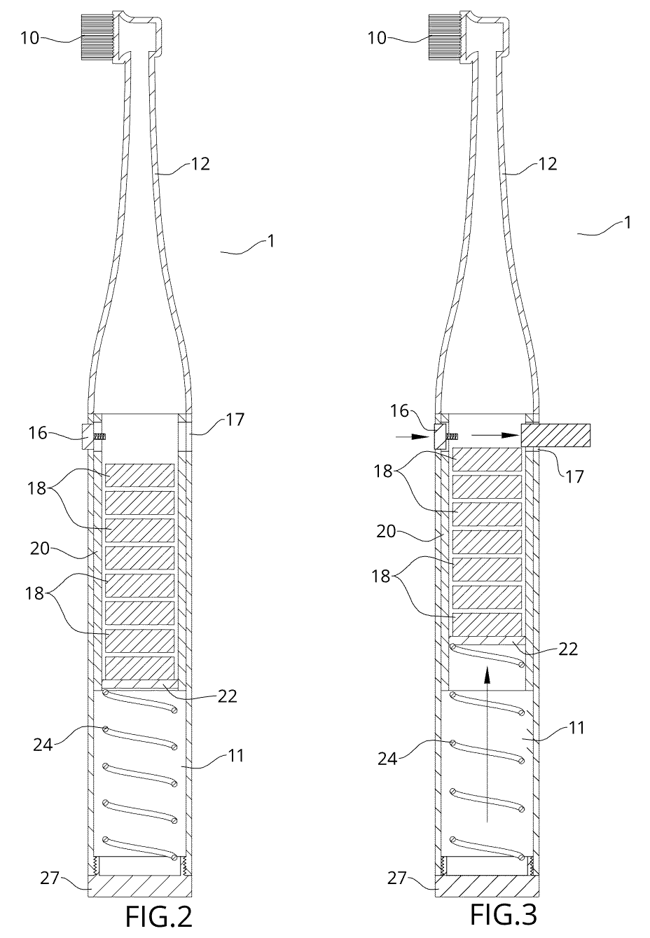

In embodiments, the cartridge chamber 11 can be configured to receive and hold a toothpaste tablet cartridge 20. The toothpaste tablet cartridge 20 is a replaceable unit containing a plurality of toothpaste tablets 18. The toothpaste tablet cartridge 20 is designed to slide into the cartridge chamber 11 of the handle 14. In some embodiments, the toothpaste tablet cartridge 20 has a snug fit to ensure stability and proper alignment. In some embodiments, as illustrated in FIG. 2, the toothpaste tablet cartridge 20, which is itself cylindrical, can house cylindrical shaped tablets that are arranged (stacked) with the flat surfaces abutting one another. Toothpaste tablet cartridge 20 may contain a floor 22 that slidably engages along and interior to the walls of the cartridge 20, and in particular is capable of being biased to slide in such a way by biasing member 24.

In embodiments, the toothpaste tablet cartridge 20 can be placed into the handle by removing the cap 27 and inserting the toothpaste tablet cartridge 20 into the cartridge chamber 11. The cap 27 can then reinstalled in the opening of the cartridge chamber 11. The biasing member 24 applies pressure to the base of the toothpaste tablet cartridge 20, ensuring that the tablets are pushed forward towards a dispensing mechanism located at a proximal end of handle 14.

In embodiments, the dispensing mechanism of the handle 14 can include a dispensing button 16 and an ejection door 17. The dispensing button 16 can be positioned on one side of the handle 14 adjacent to the proximal end of the handle, and the ejection door 17 can be positioned on the handle 14 opposite the dispensing button. In some embodiments, the dispensing button 16 can be a spring-loaded button.

In operation, as illustrated in FIG. 3, when the dispensing button 16 is depressed, the dispensing button 16 applies a force, approximately perpendicular to a long axis of the toothpaste tablet cartridge 20, to a topmost tablet 18 lcoated at a proximal end in the toothpaste tablet cartridge 20. The force applied pushes the topmost tablet 18 through the ejection door 17, thereby exiting the handle 14 for use by a user of the toothbrush 1. The biasing member 24 applies a force, approximately parallel to the long axis of the toothpaste tablet cartridge 20, to a distal end of the toothpaste tablet cartridge 20 thereby moving the remaining tablets 18 upward in the toothpaste tablet cartridge 20.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A toothbrush, comprising:
a toothbrush top comprising a head with a plurality of toothbrush bristles;
a handle coupled to the toothbrush top, the handle comprising:
a chamber formed within an interior of the handle,
an opening positioned at a distal end of the handle and providing access to the cavity,
a cap removably coupled to the handle at the opening, wherein the cap covers the opening,
a dispenser button coupled to the handle at a proximal end of the handle, and
an ejection door coupled to the handle opposite the dispenser button; and
a toothpaste tablet cartridge storing a plurality of toothpaste tablets and configured to be inserted into the chamber, wherein a topmost tablet of the plurality of toothpaste tablets is ejected from the ejection door when the dispenser button is actuated.

2. The toothbrush of claim 1, wherein the handle further comprises:
a biasing member coupled in an interior surface of the cap, wherein the biasing member applied a force to a distal end of the toothpaste tablet cartridge to move the plurality of toothpaste tablets toward a proximal end of the toothpaste tablet cartridge when the topmost tablet is ejected.

3. The toothbrush of claim 2, wherein the biasing member is a spring.

4. The toothbrush of claim 1, wherein the cap further comprises:
a plurality of threads configured to engage a plurality of corresponding threads formed on an interior surface of the chamber, adjacent to the opening.

5. The toothbrush of claim 1, wherein the dispenser button is spring loaded.

6. The toothbrush of claim 1, wherein the toothbrush is an electric toothbrush.

7. A toothbrush, comprising:
a toothbrush top comprising a head with a plurality of toothbrush bristles; and
a handle coupled to the toothbrush top, the handle comprising:
a chamber formed within an interior of the handle, wherein the chamber is configured to receive a toothpaste tablet cartridge storing a plurality of toothpaste tablets,
an opening positioned at a distal end of the handle and providing access to the cavity,
a cap removably coupled to the handle at the opening, wherein the cap covers the opening,
a dispenser button coupled to the handle at a proximal end of the handle, and
an ejection door coupled to the handle opposite the dispenser button, wherein a topmost tablet of the plurality of toothpaste tablets is ejected from the ejection door when the dispenser button is actuated.

8. The toothbrush of claim 7, wherein the handle further comprises:
a biasing member coupled in an interior surface of the cap, wherein the biasing member applied a force to a distal end of the toothpaste tablet cartridge to move the plurality of toothpaste tablets toward a proximal end of the toothpaste tablet cartridge when the topmost tablet is ejected.

9. The toothbrush of claim 8, wherein the biasing member is a spring.

10. The toothbrush of claim 7, wherein the cap further comprises:
a plurality of threads configured to engage a plurality of corresponding threads formed on an interior surface of the chamber, adjacent to the opening.

11. The toothbrush of claim 7, wherein the dispenser button is spring loaded.

12. The toothbrush of claim 7, wherein the toothbrush is an electric toothbrush.
